(19) United States
(12) Patent Application Publication
(10) Pub. No.: US 2023/0334108 A1
(43) Pub. Date: Oct. 19, 2023

(54) Method and System for Virtualization of On-Line Navigation

(71) Applicants: Robert Lewis Michaels, JR., Austin, TX (US); Jordan Edward King, Cedar Park, TX (US)

(72) Inventors: Robert Lewis Michaels, JR., Austin, TX (US); Jordan Edward King, Cedar Park, TX (US)

(21) Appl. No.: 18/135,114

(22) Filed: Apr. 14, 2023

Related U.S. Application Data
(60) Provisional application No. 63/331,226, filed on Apr. 14, 2022.

(51) Int. Cl. G06F 16/954

(52) U.S. Cl. CPC G06F 16/954

(57) ABSTRACT

The disclosed technology decouples online navigation systems from the underlying source and structures of online presentation hosts, e.g. web pages, phone apps, metaverse environments, and inject dynamic, personalized and relevant navigation options deployed and managed from the cloud and rendered into target online display host(s) at runtime, enabling navigation objects to be dynamic, interconnected, centrally managed and deployable across one or more online display hosts.

### CROSS REFERENCE TO RELATED TO PATENT APPLICATIONS

This patent application claims priority to U.S. Provisional Pat. Application No. 63/331,226, filed Apr. 14, 2022, by co-inventors Robert Lewis Michaels, Jr. and Jordan Edward King, the disclosure of which is incorporated herein by reference in its entirety.

### BACKGROUND

Websites consist primarily of navigation objects. A navigation object is any clickable, tappable, or otherwise actionable object or collection of objects presented within a website that hyperlinks to different online destinations, such as destination pages. Current website navigation systems are designed and developed to be delivered via, and are dependent upon, the underlying source code of individual websites and are limited in scope to the domain(s) and underlying source code that presents them.

Further, because current navigation systems are dependent on the underlying structure of an online system, changing a navigation system or method to assist end-users in bypassing dense content requires significant modification to underlying structures.

### BRIEF SUMMARY

Traditionally, navigation objects making up websites are static and are tethered to a website’s design. The disclosed method and system decouples navigation objects from the website design, underlying source code, and presentation location to display more relevant online destination options to website visitors. This method can be used to present relevant destination options via any connected online user interface display. The disclosed method and system enable cloud management of navigation objects, which are rendered into any online display host via code injection.

The disclosed method leverages cloud-based management of navigation objects, which can include text, images, HTML, CSS, and other UI codes, languages, and scripts. Destination locations, style options, functional configurations, and other capabilities related to displaying and controlling the navigation objects are presented separately from the page source code in which they display.

In one embodiment, the disclosed method of providing virtualized navigation includes storing navigation objects (102) in a cloud computing system (101). The method includes transmitting via the Internet (104) a navigation object (102) to a display host (105) that receives the navigation object. The method also includes presenting the received navigation object (102) in the display host (105). The method further includes displaying a destination indicated by the received navigation object. In this manner, decoupling of navigation from display instances through virtualization is achieved by injecting a centrally managed and processed navigation component into an online display.

### BRIEF DESCRIPTION OF THE DRAWINGS

The appended drawings illustrate only exemplary embodiments of the invention and therefore do not limit its scope because the inventive concepts lend themselves to other equally effective embodiments.

FIG. 1 is a block diagram of one embodiment of the disclosed system showing major components thereof.

FIG. 2A is a flowchart showing major process steps of the disclosed navigation method.

FIG. 2B is a flowchart showing process steps of the disclosed navigation method in more detail.

FIG. 3 is a flowchart showing a sequence of actions performed when a virtual navigation is being displayed.

FIG. 4 is a flowchart showing a representative processing of the disclosed virtual navigation object any time it is being displayed.

FIG. 5 provides an overview of the process in which a redirect plug-in script intercepts the rendering and adding the Navigation.

FIG. 6 is a block diagram of components of the disclosed system for virtualization of on-line navigation.

FIG. 7A is an image of a presentation to the user that does not use the disclosed Navigation 102 and that does not enjoy the benefits of the disclosed virtualized navigation system and method.

FIG. 7B is an image of a presentation to the user that employs the disclosed Navigation technology 102 to achieve virtualized navigation.

FIG. 8 is a representation that depicts aspects of conventional web navigation to provide static navigation.

FIG. 9 is a representation that depicts elements that the disclosed system employs to achieve the benefits of virtual web navigation.

FIG. 10 shows an embodiment of the disclosed technology that includes the overall network of systems that may be employed to achieve virtual navigation.

FIG. 11 shows a representative overall network of physical systems that includes particular computing devices employed to achieve virtual navigation.

FIG. 12A depicts presentation of a native main navigation object and native general navigation object within the context of a user interface.

FIG. 12B depicts presentation of the dynamic window containing injected navigation content and actionable navigation objects within the context of a user interface.

FIG. 13 depicts an information handling system (IHS) that may be employed as the computing devices used by the disclosed system and method.

### DETAILED DESCRIPTION

This disclosed technology relates to a method and system that deliver online navigation in a new and novel way by decoupling navigation objects from online display hosts and delivering navigation objects managed in the cloud into online display hosts, allowing users to interact with the navigation objects to expedite access to desired online destinations, e.g. another web page, a different application screen, or other online presentation.

The disclosed technology further relates to a method and system for creating, managing and deploying individual online navigation objects that can be dynamically interconnected and strategically injected throughout an online system to rapidly deploy and manage standardized navigation objects that present focused, pre-curated navigation options to online destinations and relevant information to content consumers.

More specifically, the disclosed technology relates to a novel technique for creating, managing and deploying an online distribution system of dynamic navigation objects distributed throughout an online system that work in concert to lead users to relevant online destinations. The technique relies on injecting and rendering dynamic, stand-alone or interconnected navigation systems into online display hosts.

As noted above, since current navigation systems are dependent upon the underlying structure of an online system, changing a current navigation system or method to assist end-users in bypassing dense content typically requires major changes to underlying structures. This often involves a complete overhaul of existing code at great expense to the website proprietor or other entity.

Through decoupling navigation objects, online content managers can use a central yet separate and automated system to enhance, replace, or otherwise change the navigation without involving or modifying the host online system’s underlying structure(s).

Current navigation systems present a single navigation object with the same options, in the same order, in the same style for every display instance of the navigation. At best, they rely on directing users based on personas, with limited ability to present specific navigation options relevant to the user’s previous behavior.

However, once the navigation is decoupled from the display host using the disclosed methodology, the navigation management system can process the navigation object where it is stored, as well as each time it is being displayed. Through unique points of processing, computing can be performed on the navigation display prior to presentation, optimizing pathways to relevant content for users at runtime.

In more detail, a novel way of presenting website navigation is disclosed wherein the native navigation inherent in the code of web pages is replaced by cloud-based navigation. Testing has shown this approach to offer significant performance advantages when a website user attempts to find desired content on a website. This approach is applicable to pages with contextual menus such as drop-down menus and flyout menus. It is also applicable to path-based navigation. In conventional path-based navigation, when the user goes to a website they may encounter “call to action” elements that attempt to direct the user to desired content. These “call to action” elements are designed to resonate with particular personas of users. The website developer may place these “call to action” elements on multiple landing pages and top level pages in the hope that a user with a particular persona will be interested and click on (i.e. select) it and be directed to a destination page with desired content sought by the particular user.

With such a path-based navigation approach that is employed on conventional webpages via hard coding, the user may have to click through several landing pages or need to scroll and scroll though multiple webpages in hopes of finding desirable content. This approach may consume a large number of webpages to implement as the user clicks around on different webpages to find desired content. Moreover, it can prove to be very frustrating for the user seeking the desired content if they need to look at many webpages to find desired content. This is akin to the time taken flipping through the pages of a magazine to find desired content.

In one embodiment, the disclosed methodology consolidates path-based navigation. Whereas previously the user may be required to scroll and scroll on a webpage, and there are many such webpages attempting to direct a user to a webpage with desired content, funneling users to a desired content webpage can be performed in a single dynamic window that is presented to the user on the website’s home page. The user may effectively pre-filter their choices to more directly get to a desired content destination page by engaging the dynamic window presented on the website’s home page. The dynamic window includes elements that resonate with, i.e. attract, users with particular personas, namely particulars interests. The user selects, i.e. clicks on, an element in the dynamic window that is attractive to the user. In this manner, lengthy user navigation to a destination page through a homepage, landing page, main section page, sidebar navigation is avoided. Advantageously, this methodology avoids page loads which is especially helpful to user’s searching on mobile devices that load at the top of a webpage, thus requiring the user to scroll and scroll. Replacing page-based navigation of website content with the disclosed navigation methodology enables tracking of usage and selections by users at an individualized level to provide user data.

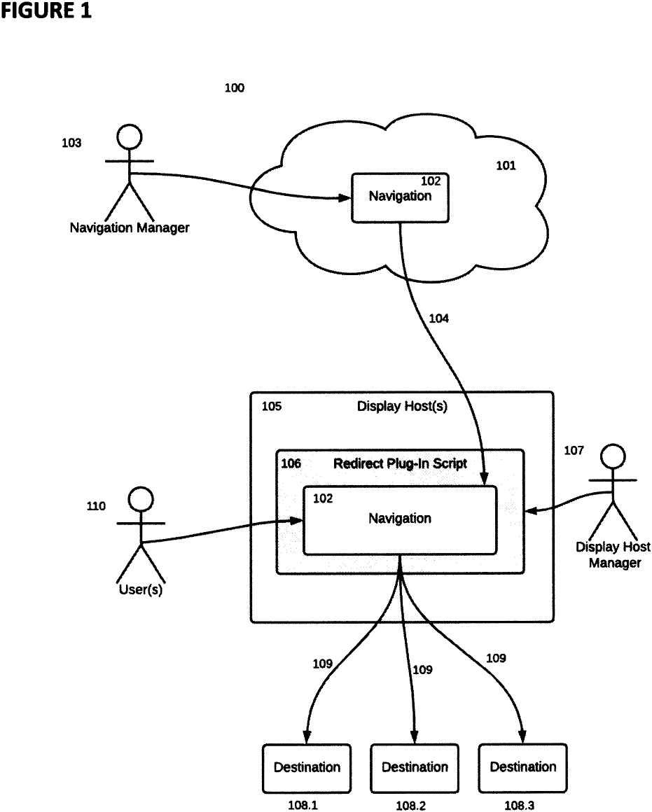

The following is a list of selected elements that are referenced in FIGS. 1-13 of this specification:
100 system
101 cloud
102 navigation object
103 navigation manager
104 processing step
105 display host(s)
106 redirect plug-in script
107 display host manager
108.1 destination
108.2 destination
108.3 destination
109 user workflows

FIG. 1 illustrates a networked system 100 that provides a navigation object to online displays per the disclosed methodology. Network 100 includes a management system in the cloud 101 in which a customer manages their navigation object(s) 102.

“Cloud computing” refers to storing information such as data and software, typically on off-site servers, to provide computing services to remote users. A cloud service may be a public commercially available cloud storage such as Amazon Web Services (AWS) or the IBM cloud. Private cloud storage and computing resources are also possible.

A Navigation object 102 is a compilation of content (including, but not limited to, text, image, HTML, CSS, and other UI codes, languages, and scripts), Destination 108 locations, style options, functional configurations, and other capabilities related to displaying and controlling the Navigation 102. The Navigation Manager 103 is the entity that owns or manages a Navigation object 102. The Navigation Manager 103 manages the Navigation object’s 102 content, Destination 108 locations, style options, functional configurations, and other capabilities related to displaying and controlling the Navigation 102. A user 110 interacts with the Navigation 102.

A Display Host 105 is any internet/intranet connected user interface display. Examples of a Display Host 105 are a web page, an app screen on a phone, computer, tablet, refrigerator display, or other internet connected devices. Any Display Host Manager 107 can add a Navigation 102 to a Display Host 105 by adding a redirect plug-in script 106, a few lines of code or a control that generates that code, with a configuration of which Navigation 102 to display within the Display Host 105. Additionally, the Display Host Manger 107 can set configuration options for the Navigation object 102 through the redirect plug-in 106. The redirect plug-in 106 loads the specified Navigation object 102 providing it any configuration options. The loaded Navigation object 102 is processed 104 and rendered into the Display Host 105. An end-user is then able to interact with the Navigation object 102 through any method that ends in sending the end-user to a Destination such one of Destinations 108.1, 108.2, 108.3 or any that are configured. A Destination 108 is any direction of the end-user’s workflow 109 to a new screen/view/display within or outside of the Display Host 105 environment. Examples of direction of the end-user’s workflow 109 to a Destination 108 are a hyperlink or scripted redirection on a web page that goes to another web page or opens an app, or a banner in the metaverse that portals a user to a new meta location.

FIG. 1 provides an overview of a method of virtualization of navigation. Due to this virtualization, the Navigation object 102 has the unique capability to be programmatically processed 104 dynamically immediately before display into a Display Host 105 for the specific end-user. Leveraging this ability to process 104 the Navigation object, the disclosed system can perform any number of programmatic processing 104 to the Navigation object 102. One example is to check color context of a Display Host 105 to adjust the colors displayed in the Navigation object 102_for accessibility. Another example is to check if the end-user has previously made a selection in a Navigation object 102 and calculate that a different Navigation object should be displayed.

This virtualization also creates a unique ability for the data of Navigation objects 102 to be processed independently within management system in the cloud 101. This provides a unique opportunity to do any number of actions with the data of a Navigation object 102 within the management system. One can routinely check for broken links, validate accessibility, check spelling, calculate and suggest changes to the Navigation Manager 103, automate Navigation object’s 102 text language translations, schedule and activate a change of Navigation 102 options, and many more possibilities.

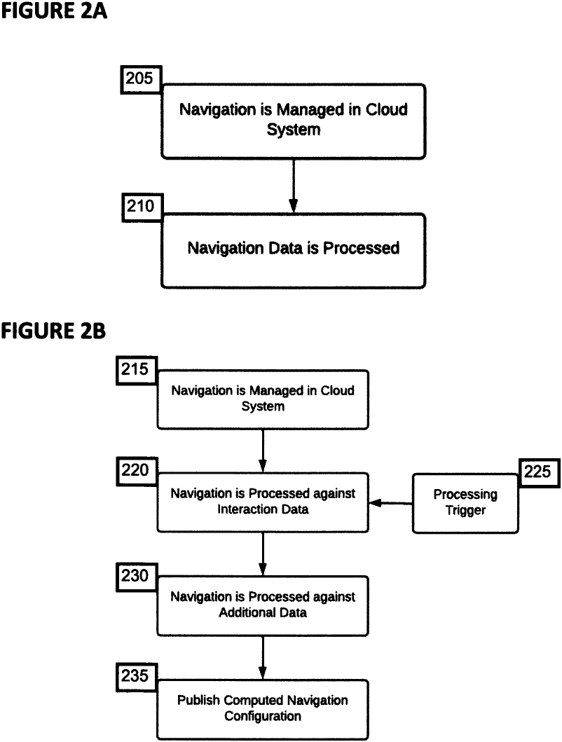

FIG. 2A shows the actions that are part of managing the virtualized Navigation object in the cloud management system. First, the Navigation object 102 is managed in a cloud system, as per block 205. Next, within this management system, after the Navigation object 102 is created, as per block 210 the Navigation object 102 can have its data processed as described in FIG. 1′s description above.

FIG. 2B shows an example of just one possible way to process a Navigation 102, as per block 220. First, as per block 215, Navigation 102 is managed in a cloud system, or as per block 225 an external process could trigger an initialization. Next, the Navigation 102 is enhanced based on user interactions with it or similar Navigations 102. Next, the Navigation is enhanced based on additional data, such as current events, as per block 230. Finally, the Navigation 102 is sent for end-user 110 access, as per block 235 at which the computed navigation configuration is published.

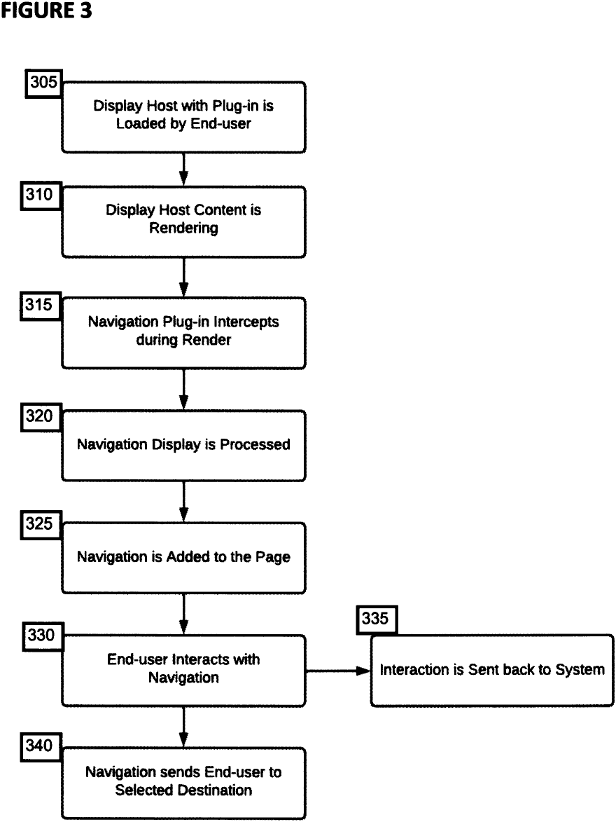

FIG. 3 is a flowchart showing the sequence of activities that occur when a Navigation object 102 is displayed and used. First, the Display Host 105 is loaded by an end-user 110, as per block 305. Second, the end-user’s 110 system loads the data from the Display Host 105 and renders that data, as per block 310. Since the redirect plug-in 106 is in the Display Host 105 it loads the Navigation object 102 from the management system 101. Third, the Navigation object 102 script intercepts the display of static navigation as per block 315 and thus the Navigation 102 can be processed 104 as described in FIG. 1′s description. After processing, the Navigation object 102 is displayed into the Display Host 105, as per block 320. After that, the end-user 110 interacts with the Navigation object 102, as per block 330. That interaction is then communicated back to the management system 101, as per block 335. Finally, as a result the end-user’s workflow 109 terminates based on the end-user’s 110 interaction with the Navigation object 102. The navigation sends the end-user to a selected destination, as per block 340.

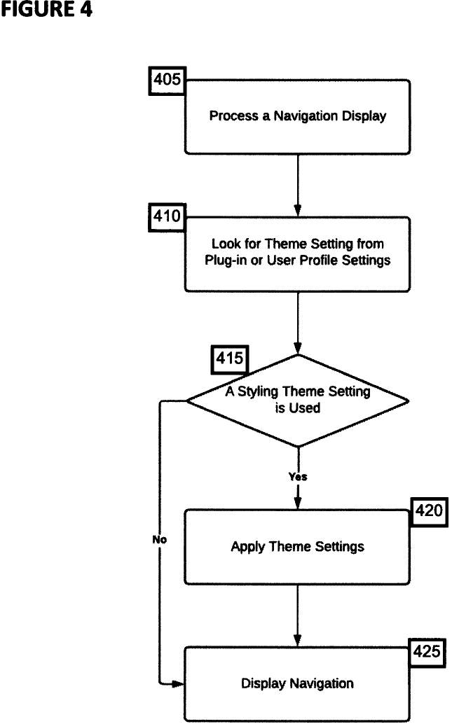

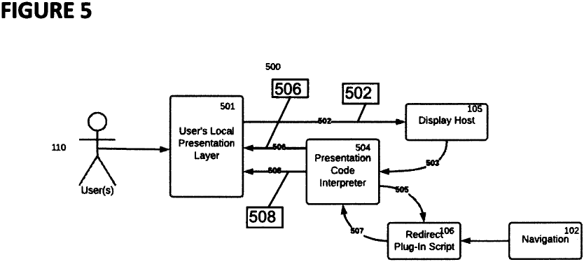

FIG. 4 is a flowchart that shows processing a Navigation display by the disclosed system. This is an example of processing 104 shown in FIG. 1, as opposed to actual navigation 109. As per the flowchart of FIG. 4, process flow commences at block 405 to process a Navigation display. A theme setting is looked up from redirect plug-in 106 or user profile settings, as per block 410. A test is then conducted to determine if a styling theme setting is being used, as per decision block 415. If the test determines that a styling theme is being used, then those settings are applied, as per block 420, and navigation is displayed, as per block 425. However, If the test determines that a styling theme is not being used, then navigation is displayed without the need to apply other settings, as per block 425.

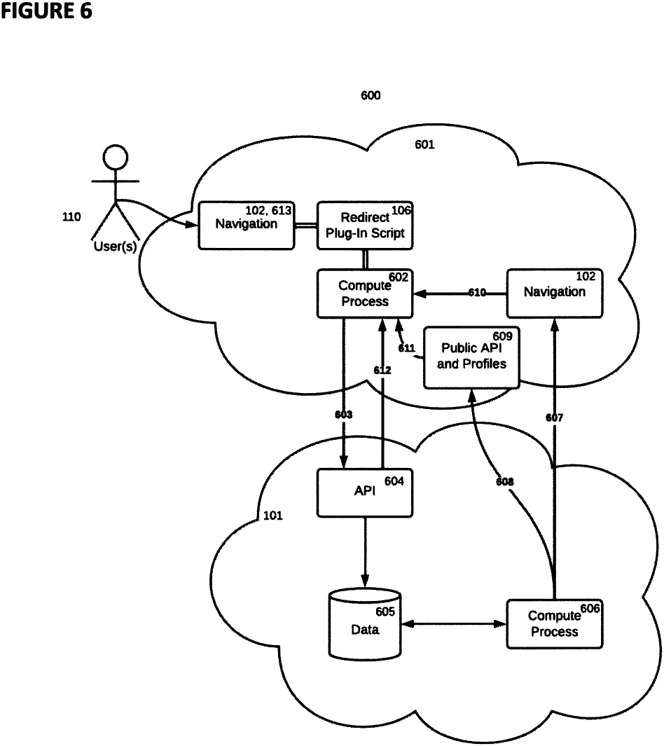

FIG. 5 provides an overview of the process in which the redirect plug-in 106 intercepts the rendering and adding the Navigation 102. The end-user’s 110 system, such as a browser, which has a presentation layer 501, requests data 502 from the Display Host 105. The data provided back 503 must be interpreted by presentation code interpreter 504, or translated, for appropriate presentation. This interpretation process 504 will load 505 the redirect plug-in 106 which will load and compute 104, seen in FIG. 1, the Navigation 102 to provide back 507 to the interpreter 504. The presentation layer 501 then presents the presentation 506 from the Display Host 105 with the Navigation 102 integrated 507 by the redirect plug-in 106. FIG. 6 shows how one could use the unique processing capabilities of virtualized navigation. When an end-user 110 connecting through a network 601, such as an internet or intranet, is presented a Navigation 102 through a redirect plug-in 106 the script is able to process 602 the interaction and compute the presentation transforming Navigation 102 into Navigation 613.

First, when a user 110 interacts with a Navigation 102,613 the interaction is processed 602 and sent 603 to an API 604 in the cloud management system 101. The API 604 stores the interaction data to the data storage 605. Stored Data 605 may also consist of the Navigations 102 and results of processing 606 within the cloud system 101 as well as other data such as the results of processing current events or additional demographic information. Computational processing 606 can be run upon any variety of triggers such as time or manual or automatic initialization. This processing 606 may use and amend the Data 605 through a variety of computations including scripted and Artificial Intelligence processing, language translation, and scheduled content. The processing 606 of Data 605 and Navigations 102 can send updates 607 of the Navigation 102 and send data 608 to the Public API 609 on the network 601. The Navigation 102, Public API 609, and API 604 can all provide data to be used by the processing 602 to calculate the best unique version of the Navigation 613 for the unique end-user 110.

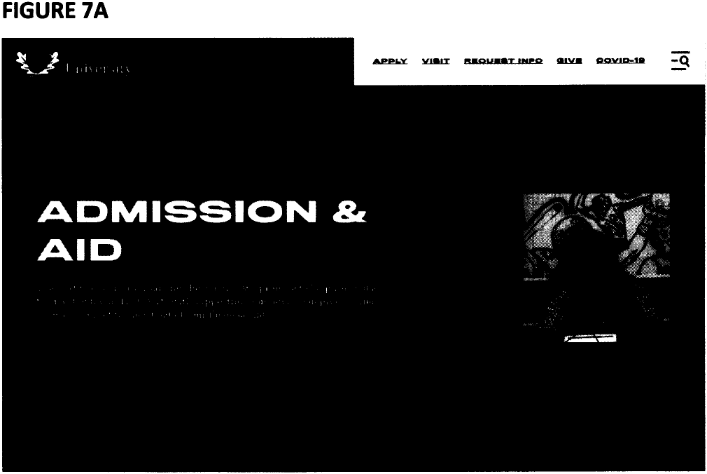

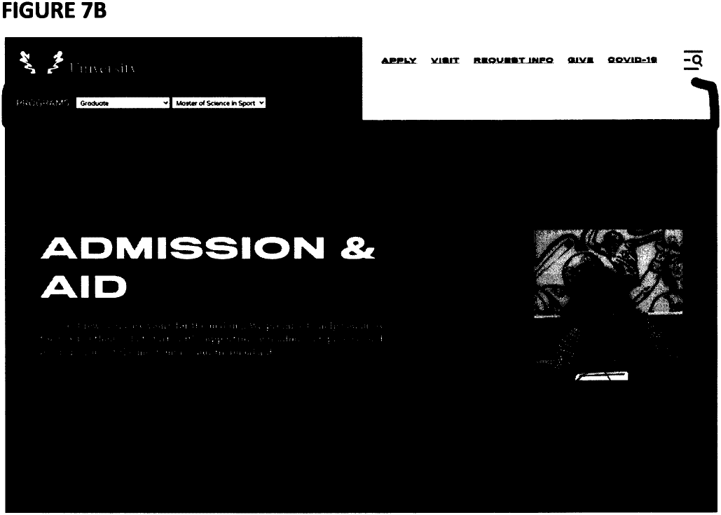

FIG. 7A and FIG. 7B are respectively images of before and after the addition of a Navigation 102 into the Display Host 105 presentation. More specifically, FIG. 7A is a presentation without the addition of Navigation 102. FIG. 7B shows the same presentation with Navigation 102, highlighted with red markings, integrated with the Display Host 105 presentation.

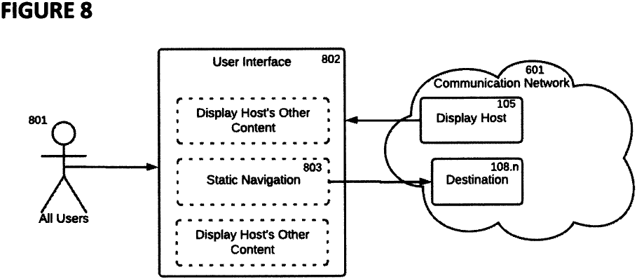

FIG. 8 shows the components involved when the disclosed system and methodology is not employed. Is that case, when any and All Users 801 view a User Interface (UI) 802 delivered by a Display Host 105 from a Communication Network 601 such as the internet or an intranet, the UI 802 presents the content as delivered by the Display Host 105. This content includes Static Navigation 803 which takes a user 801 to any of a destination 108.n (e.g. 105.1, 108.2, 108.3,...). The Static Navigation 803 would not be customized to the user nor the UI’s 802 context. The interaction with the Static Navigation 803, including sending the user to the Destination 108.n, would not be recorded and be useable for improving navigation.

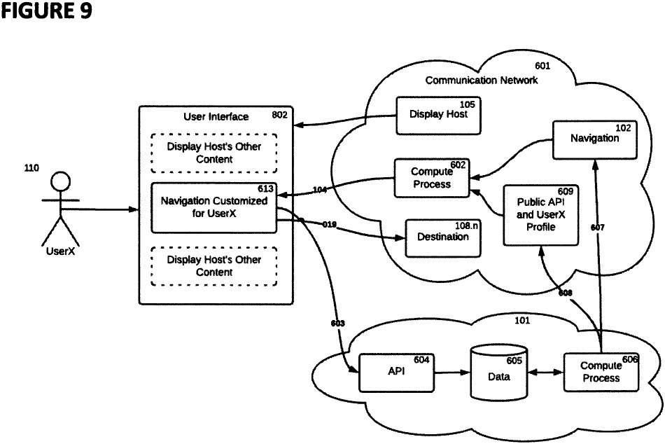

FIG. 9 shows the components employed in the disclosed method and system. In one embodiment, when a user, UserX, 110, identified by digital fingerprint, federated id, or other id, views a User Interface (UI) 802 delivered by a Display Host 105 from a Communication Network 601 such as the internet or an intranet, the UI 802 presents the content as delivered by the Display Host 105. This content includes the redirect plug-in 106 which computes 602 the Navigation 102 in combination with processed 606 data 605 for APIs and User Profiles 609 to dynamically create the Navigation Customized for UserX 613. While still sending the user to the destination 105 the Navigation 102, 613 can then send any interactions to the system’s 101 API 604 to record the interactions for making navigations 613 better.

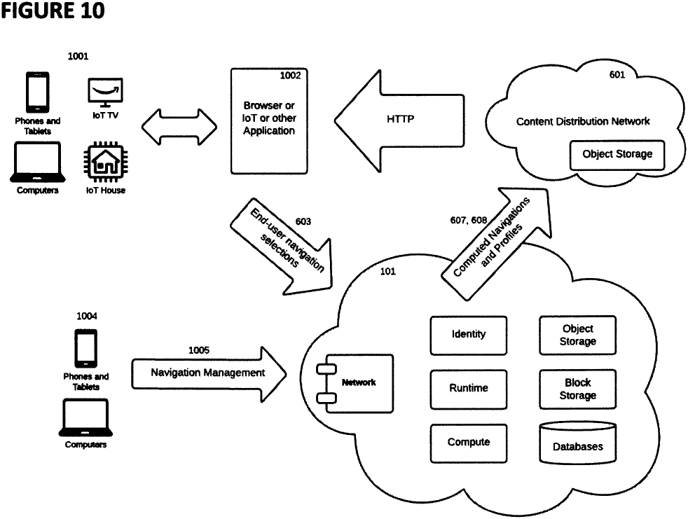

FIG. 10 represents the overall network of systems directly related to the disclosed system and methodology in one embodiment. Any computer 1001 with an application 1002, such as a browser or IoT device, connected to a network 601 can connect to the disclosed system. The system 101 includes data storage, processing computation, network interaction, identity management, and other computer systems to support the system 101. Customers can use computers 1004 to authenticate, connect to and manage 1005 owned Navigations 102 and access reports in the system 101. The system 101 will compute and process and push the computed Navigation, Profile, and other configurations 607, 608 to support the Computer Processes 602 to customize the Navigation 613.

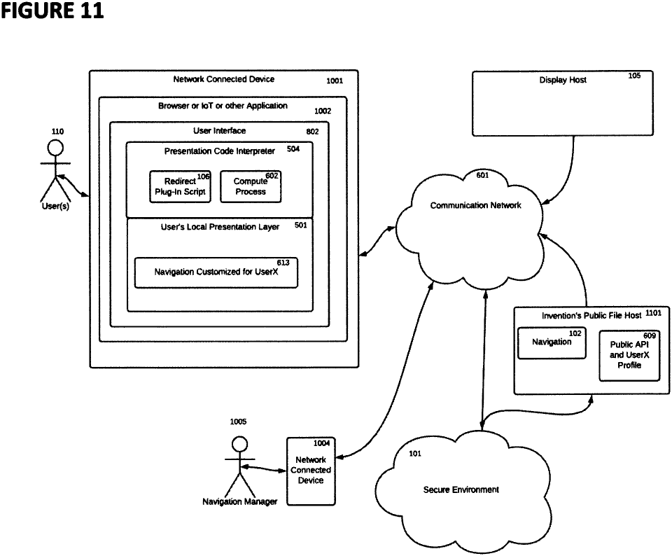

FIG. 11 presents the common, existing computation devices that can be employed in one embodiment of the disclosed system and methodology, and shows more clearly, the boundaries that “physically” separate significant parts the structures in the other drawings. A user 110 uses a network connected device 1001, such as a computer, phone, or IoT device to connect to the Communication Network 601 such as the Internet. Their device 1001 communicates through the network 601 to request content form a Display Host 105 provider. One very common form of a Display Host 105 is a web server that responds to HTTP requests with HTML and supporting files such as PDFs, images, and CSS styles. As described with respect to FIG. 9, the redirect plug-in script 106 is delivered through the network 601 runs the compute process 602 to render the Navigation 613 in an application 802 on the display screen of the user’s device 1001. The redirect plug-in script 106 sends data through the network 601 to the secure cloud environment 101 for computation and storage. Navigation Manager 1005 users connect, using their own network connected device 1004, through the network 601 to the computation cloud 101. Computation cloud 101, like 105 is commonly a web server whether it is a single computer webserver that contains the ability to compute and store for the system as seen in FIG. 10. The disclosed system and methodology saves data to a file host 1101, such as a Content Distribution Network or another web serving computation environment. The saved data can include, but is not limited to, general data such as time, date, user agent, and IP address, as wel as specific user interaction data such as the order of selections made or the title and URLR of a button. The file host 1101 can be public or non-public access. Typically, it will be public to increase speed for rendering for users 110.

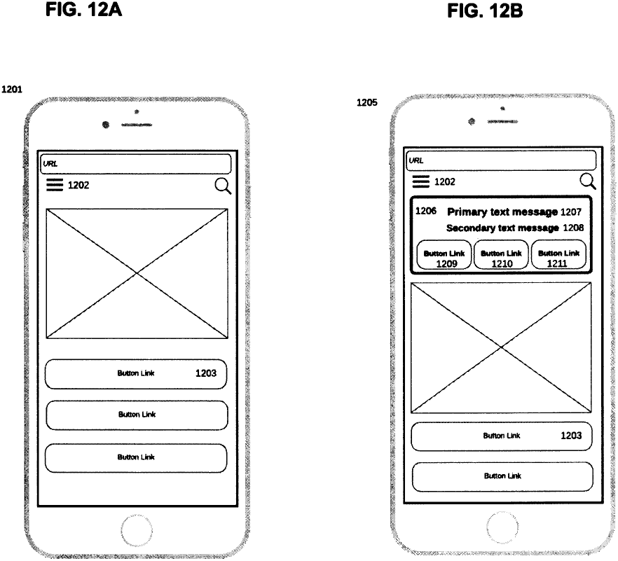

FIG. 12A depicts the display of a representative computing device 1201 that the end-user may employ to access information on webpages using conventional methods. More particularly, FIG. 12A depicts presentation of native main navigation object 1202 and native general navigation object 1203 within the context of a user interface. FIG. 12B depicts presentation of the dynamic window 1206 containing injected navigation content 1207, 1208 and actionable navigation objects 1209, 1210, 1211 within the context of a user interface.

As one example, dynamic window 1206 can present weather alert information, where injected navigation content 1207 can be a primary call-to-action message presented in a particular visual style. For instance, the injected navigation content element 1207 can contain text warning of an impending hurricane. Additional supporting information 1208 can be presented to provide more detail Actionable element 1209 can be a link to preparedness content. Actionable element 1210 can be a link to evacuation route content, and actionable element 1211 can be a link to recovery assistance content. For comparison, it is noted that FIG. 12A depicts an embodiment of a conventional computing device that does not employ the disclosed methodology, whereas FIG. 12B shows a computing device employed in a system that uses the disclosed methodology.

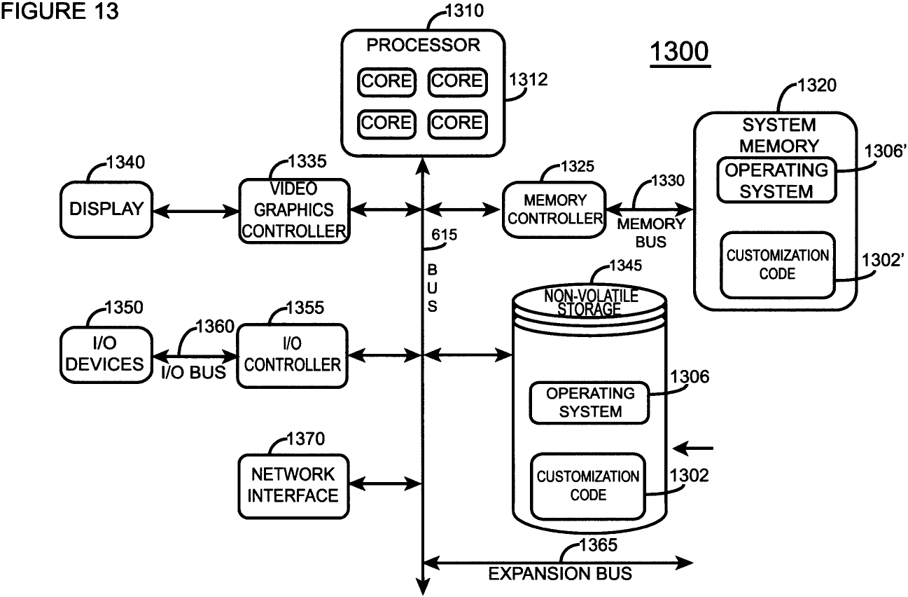

FIG. 13 is a block diagram of an information handling system (IHS) that may be employed as the user’s computing device, the data center computing system, and the cloud-based content navigation computing system when each is programmed, i.e. customized, to carry out the respective methods described herein for these systems. IHS 1300 includes a processor 1305 that may include multiple cores. IHS 200 processes, transfers, communicates, modifies, stores or otherwise handles information in digital form, analog form or other form. IHS 1300 includes a bus 1310 that couples processor 205 to memory 215 via a memory controller 220 and memory bus 225. System memory 1315 may also be referred to as main memory. System memory 3115 may be a static random access memory (SRAM) array or a dynamic random access memory (DRAM) array. Processor 1305 may also include local memory such as L1, L2 and L3 caches. A video graphics controller 1330 couples display 235 to bus 1310. Nonvolatile storage 240, such as a hard disk drive, solid-state drive (SSD), CD drive, DVD drive, Blu-Ray drive or other nonvolatile storage couples to bus 1310 to provide IHS 1300 with permanent storage of information. System memory 215 and nonvolatile storage 1340 are both forms of memory stores. Nonvolatile storage 1340 stores an operating system 1345 (OPERATING SYS) that governs operation of IHS 1300. I/O devices 1350, such as speakers, a keyboard and a pointing device, couple to bus 1310 via I/O controller 1355 and I/O us 1360

One or more expansion busses 1365, such as USB, IEEE 1394 bus, ATA, SATA, PCI, PCIE, DVI, HDMI and other busses, couple to bus 1310 to facilitate the connection of peripherals and devices to IHS 200. One or more expansion busses 265, such as USB, IEEE 1394 bus, ATA, SATA, PCI, PCIE, DVI, HDMI and other busses, couple to bus 1310 to facilitate the connection of peripherals and devices to IHS 1300. A network interface controller (NIC) 1370 couples to bus 1310 to enable IHS 1300 to connect by wire or wirelessly to a network and other information handling systems. NIC 1370 may also be called a network communication adapter, network interface adapter, network adapter, network interface or an adapter. While FIG. 13 shows one IHS that employs processor 1310 with multiple cores, the IHS may take many forms. For example, IHS 1300 may take the form of a desktop, portable, laptop, notebook, tablet or other form factor computer or data processing system. Many such IHS’s may be coupled together to form a data center that may be employed in the disclosed system and methodologies including for example network connected device 1001, display host 105 and secure computing environment 101.

In one embodiment, a series of strategically deployed Navigation objects may be used to display a program finder tool for a university to drive perspective students on their website directly to a program of interest, skipping a complex series of global and contextual navigation selection tasks.

In another embodiment, a business could display Navigation objects on a billboard in the metaverse. The disclosed methodology can be used to manage the navigation for the billboard in a cloud-based management system that displays navigation objects to direct visitors to the business’ metaverse environments via an interactive billboard within the metaverse.

The disclosed system and methodology is particularly useful in managing large websites such as employed by universities, companies, government, and others. Websites have become so large and sprawling that they are difficult and expensive to manage. When a user goes to a website, it is often hard for the user to find the desired destination. As described above, everything the user “clicks on” until the user reaches the desired destination on the website is referred to as “navigation”, i.e. the way the website is laid out. The navigation/layout is part of the design (i.e. code and pages) of a website and is often very difficult to change. The disclosed methodology provides direct paths to desired destinations so that the user does not need to root around through uncurated content on a website before reaching the desired destination.

The disclosed methodology described above effectively provides a new presentation layer to the internet. It enables the user to cut through many of the items on a website that are not relevant to a particular search for a destination. When people search on the internet for a destination using today’s search engines, the search engine reports vast amounts of un-curated content and code that may have been written many years ago. Often the user winds up without reaching the desired destination. The vast and ever-increasing size of the Internet has made indexing by search engines very difficult. This is one more reason to use the disclosed methodology as opposed to current technology.

The disclosed methodology effectively provides a decoupled website navigation solution that resides in the cloud and which is completely injectable into the website. It dynamically, seamlessly integrates with all user interfaces and resides in any renderable page of the website.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. It will be also understand that the terms “including” and “having” are synonymous.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Process steps may be performed in an order different than those presented for purposes of example. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

It is to be understood that the present disclosure may assume various alternative orientations and step sequences, except where expressly specified to the contrary. It is also understood that the specific devices and processes illustrated in the attached drawings, and described in the specification are simply exemplary embodiments of the inventive concepts disclosed and defined herein. Hence, specific dimensions, directions or other physical characteristics relating to the various embodiments disclosed are not to be considered as limiting, unless expressly stated otherwise.

What is claimed is:

1. A method of providing virtualized navigation, comprising:
storing navigation objects (102) in a cloud computing system (101);
transmitting via the Internet (104) a navigation object (102) to a display host (105) that receives the navigation object;
storing the received navigation object (102) in the display host (105); and
displaying a web page destination indicated by the received navigation object (102),
whereby decoupling of navigation from display instances through virtualization is achieved by injecting a centrally managed and processed navigation component from the cloud computing system (101) into an online display.

2. The method of claim 1, wherein the on-line display is situated in an end-user’s computing device that is responsive to the display host.

3. The method of claim 2, wherein the end-user’s computing device includes a web browser on which the end user requests content from the display host (105).

4. The method of claim 1, including storing a redirect plug-in script in the display host (105).

5. The method of claim 1, wherein a dynamic window including injected content is rendered on the end user’s computing device by the display host.

6. The method of claim 1, wherein user choices are prefiltered to more directly reach a desired content destination page.
